(19) United States
(12) Patent Application Publication
(10) Pub. No.: US 2026/0021723 A1
(43) Pub. Date: Jan. 22, 2026

(54) BATTERY PACK WITH INTEGRATED BATTERY CHARGER

(71) Applicant: Briggs & Stratton, LLC, Wauwatosa, WI (US)

(72) Inventors: Jeffrey Zeiler, Brookfield, WI (US); Matthew Mergener, Mequon, WI (US); Ryan Jaskowiak, Eagle, WI (US); Bryce Metcalf, New Berlin, WI (US)

(73) Assignee: Briggs & Stratton, LLC, Wauwatosa, WI (US)

(21) Appl. No.: 18/994,777

(22) PCT Filed: Jul. 14, 2023
(86) PCT No.: PCT/US2023/027802

§ 371 Date: Jan. 15, 2025

Related U.S. Application Data
(60) Provisional application No. 63/389,456, filed on Jul. 15, 2022.

(51) Int. Cl. B60L 53/30; A01D 34/66; A01D 69/02; A01D 101/00; B60L 50/64; B60L 53/16; B60L 53/80; H01M 10/46; H01M 10/48; H01M 10/615; H01M 10/625; H01M 10/643; H01M 10/6571; H01M 50/213; H01M 50/249; H01M 50/271; H01M 50/296

(52) U.S. Cl. CPC B60L 53/30; B60L 50/64; B60L 53/16; H01M 10/46; H01M 10/482; H01M 10/486; H01M 10/615; H01M 10/625; H01M 10/643; H01M 10/6571; H01M 50/213; H01M 50/249; H01M 50/271; H01M 50/296; A01D 34/66; A01D 69/02; A01D 2101/00; B60L 53/80; B60L 2200/40; H01M 2220/20

(57) ABSTRACT

A battery pack includes a battery housing defining an internal cavity, a first positive terminal extending through the housing, a first negative terminal extending through the housing, a plurality of battery cells within the internal cavity, and a battery charger within the internal cavity. The plurality of battery cells are electrically coupled to the first positive terminal and the first negative terminal. The battery charger is configured to charge the plurality of battery cells and includes a second positive terminal electrically coupled to the first positive terminal within the housing, and a second negative terminal electrically coupled to the first negative terminal within the housing.

### BACKGROUND

Battery packs may be used with different types of equipment, including outdoor power equipment, vehicles, aerial man lifts, floor care devices, golf carts, lift trucks and other industrial vehicles, floor care devices, recreational utility vehicles, industrial utility vehicles, lawn and garden equipment, and energy storage or battery backup systems. Outdoor power equipment includes lawn mowers, riding tractors, snow throwers, pressure washers, portable generators, tillers, log splitters, zero-turn radius mowers, walk-behind mowers, riding mowers, and turf equipment such as spreaders, sprayers, seeders, rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment.

### SUMMARY

At least one embodiment relates to a battery pack that includes a battery housing defining an internal cavity, a first positive terminal extending through the housing, a first negative terminal extending through the housing, a plurality of battery cells within the internal cavity, and a battery charger within the internal cavity. The plurality of battery cells are electrically coupled to the first positive terminal and the first negative terminal. The battery charger is configured to charge the plurality of battery cells and includes a second positive terminal electrically coupled to the first positive terminal within the housing, and a second negative terminal electrically coupled to the first negative terminal within the housing.

Another embodiment relates to a battery pack that includes a battery housing defining an internal cavity, a first positive terminal, a first negative terminal, a plurality of battery cells within the internal cavity, a temperature sensor mounted to the housing or the plurality of battery cells, and a battery charger within the internal cavity. The plurality of battery cells are electrically coupled to the first positive terminal and the first negative terminal. The battery charger is configured dissipate energy into the housing, when a temperature measurement of the temperature sensor is below a threshold value.

Another embodiment relates to outdoor power equipment that includes a frame, a prime mover, a wheel coupled to the frame, and a rechargeable battery pack supported on the frame and configured to electrically power the prime mover. The rechargeable battery pack includes a battery housing defining an internal cavity, a first positive terminal, a first negative terminal, a plurality of battery cells within the internal cavity, and a battery charger within the internal cavity. The plurality of battery cells being electrically coupled to the first positive terminal and the first negative terminal. The battery charger configured to charge the plurality of battery cells and includes a second positive terminal electrically coupled to the first positive terminal within the housing, and a second negative terminal electrically coupled to the first negative terminal within the housing.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a mower, according to some embodiments;

FIG. 2 is a perspective view of a battery pack, according to some embodiments;

FIG. 3 is top, front perspective view of a cross section of the battery pack of FIG. 2, showing a cell module assembly (CMA) and a charger;

FIG. 4 is a top, front perspective view of a cross section of the battery pack of FIG. 2, with a cell module assembly hidden;

FIG. 5 is a top, side perspective view of the cross section of the battery pack of FIG. 4;

FIG. 6 is a perspective view of a base and a charger of the battery pack of FIG. 2;

FIG. 7 is a perspective view of a base, a charger, and a frame of the battery pack of FIG. 2;

FIG. 8 is a perspective view of the battery pack of FIG. 2 without a frame;

FIG. 9 is a block diagram of an energy balance of the battery pack of FIG. 2, according to some embodiments;

FIG. 10 is a perspective view of a CMA of the battery pack of FIG. 2;

FIG. 11 is a front view of the CMA of FIG. 10;

FIG. 12 is a side view of the CMA of FIG. 10;

FIG. 13 is a perspective view of a battery pack, according to some embodiments;

FIG. 14 is a top, front perspective view of a cross section of the battery pack of FIG. 13, showing a CMA and a charger;

FIG. 15 is a top, front perspective view of a cross section of the battery pack of FIG. 13, with a housing hidden;

FIG. 16 is a side view of a CMA of the battery pack of FIG. 13;

FIG. 17 is a top, front perspective view of a cross section of the battery pack of FIG. 13, with a CMA hidden;

FIG. 18 is a perspective view of a base and a charger of the battery pack of FIG. 13; and

FIG. 19 is a schematic illustration of a battery management system of the battery pack of FIG. 2 or the battery pack of FIG. 13.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, described herein are systems and methods for a battery pack with an integrated battery charger. Certain battery packs (e.g., rechargeable battery packs) may receive a charge from a dedicated charger (e.g., recharger, battery charger, etc.) that is electrically coupled and configured to charge the battery pack. Conventional rechargeable battery packs typically receive charging power from a battery charger that is located remotely from the battery pack. In outdoor power equipment applications, there are typically several pieces of outdoor power equipment with different battery packs and different associated chargers. So an operator is required to properly connect the battery pack to its associated charger, which brings about the potential for operator error (e.g., using incompatible chargers, using improper wiring, attaching the wrong leads or wrong order of leads, etc.).

During operation, battery chargers typically generate heat that is dissipated directly into an ambient environment. Advantageously, the systems and methods described herein provide a battery pack with an integrated battery charger. The integrated battery charger simplifies charging operation of the battery pack by eliminating a need for an operator to choose a particular battery charger that is associated a battery pack. Additionally, the integrated charger can be used to selectively heat an interior of the battery pack in predefined operating conditions.

### Zero Turn Mower

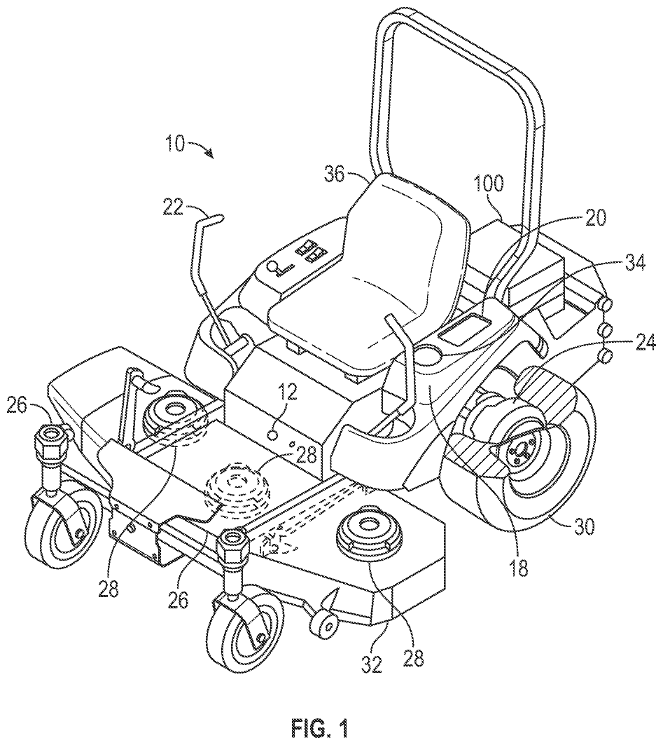

Referring to FIG. 1, outdoor power equipment is shown as mower 10. As shown, mower 10 is a zero-radius turn ride-on mower (ZTR). Although described in the context of the mower 10, the battery pack and integrated battery charger systems and methods described herein can be applicable to other chore products, including outdoor power equipment, indoor power equipment, light vehicles, aerial man lifts, floor care devices, golf carts, lift trucks and other industrial vehicles, recreational utility vehicles, industrial utility vehicles, and lawn and garden equipment. Outdoor power equipment may include lawn mowers, riding tractors, snow throwers, pressure washers, tillers, log splitters, walk-behind mowers, riding mowers, and turf equipment such as spreaders, sprayers, seeders, rakes, and blowers. Outdoor power equipment may, for example, use one or more electric motors to drive an implement, such as a rotary blade of a lawn mower, a pump of a pressure washer, the auger of a snow thrower, the alternator of a generator, and/or a drivetrain of the outdoor power equipment. Indoor power equipment may include floor sanders, floor buffers and polishers, vacuums, etc.

A “chore product” as used herein refers to any type of equipment, machine, or vehicle that may be used to perform a chore (e.g., an outdoor chore, an indoor chore, lawn care, etc.). For example, a chore product may include a motor, a pump, an actuator, a compressor, and/or another device that is electrically powered to operate some function of the chore product to facilitate performing a chore. In some embodiments, a chore is a task performed, either by a user or autonomously, at or near a household, a farm, an agricultural facility, a building, a sidewalk, a park, a parking lot, a forest, a field, and/or a lawn. In some embodiments, a chore product transports an operator and performs a chore. In some embodiments, a chore product autonomously operates to perform a chore without an operator being present on the chore product or physically/manually manipulating the chore product.

In some embodiments, the mower 10 includes a number of sensors 12 (e.g., vision sensors, camera sensors, IR transmitters, IR cameras, thermal cameras, position sensors, accelerometers, inductive sensors, etc.), one or more batteries, shown as battery pack 100, a controller 18, one or more user interfaces 20, and one or more input devices 22.

In some embodiments, the sensors 12 on the mower 10 may be positioned around the mower 10 as shown, as well as in other locations as needed for a given configuration. The sensors 12 may be all of the same type, or may be a combination of different sensor types. Sensors may include moisture sensors, rain sensors, air quality sensors, magnetic field sensors (e.g. compass), temperature sensors, digital imaging sensors, motion detection sensors, rotation sensors, gyroscopes, chemical detection sensors, and the like.

In some embodiments, the controller 18 may communicate with a homeowner's network (e.g., via Wi-Fi). In other embodiments, the controller 18 may communicate with a local communications hub or bridge, such as a communications hub associated with a service vehicle. In still other embodiments, the controller 18 may be configured to allow for the mower 10 to communicate directly with a central or cloud-based server (e.g., via a cellular connection). In some embodiments, the controller 18 may be used to communicate with a user device capable of remotely controlling the mower 10. Example user devices capable of remotely controlling the mower 10 may include dedicated remote controls, smart phones, tablet computers, laptop computers, or any other user device capable of interfacing with the controller 18.

In some embodiments, the mower 10 may further include a number of electric motors. In some embodiments, the motors are brushless DC motors. In other embodiments, the motors are one or a combination of brushed DC motors, AC motors, permanent magnet motors, etc. The mower 10 may have one or more traction motors 24 and/or one or more implement motors 28 (e.g., chore motors). In some embodiments, each of the traction motors 24 and the implement motors 28 is powered by and electrically coupled to the battery pack 100. In some embodiments, the mower 10 may have a traction motor 24 for each of the rear drive wheels 30. In further embodiments, the mower 10 may include two or more non-traction wheels 26 (e.g., hub or castor wheels), as shown in FIG. 1. In some embodiments, the castor wheels 26 may be positioned or locked into position when operating the mower 10 in certain modes.

The implement motors 28 may be used to drive one or more attachments associated with the mower 10. In some embodiments, the implement motors 28 may each drive a cutting implement, such as a rotating blade. However, in other examples, the implement motors 28 may be used to drive other attachments such as spreaders, blowers, power rakes, or other applicable attachments. In some embodiments, the attachment motors are located on a mowing deck 32. The mowing deck 32 may house the implement motors 28 and one or more cutting blades attached to each of the attachment motors. In some embodiments, the implement motors 28 may be connected via a central bus. The central bus may provide power and communications to and from other devices, such as the controller 18 and/or the battery pack 100. In some embodiments, the central bus may allow for a single connection from the mowing deck 32 to the body of the mower 10. The computing power used for the mower 10 may be distributed across all controllers 18 and controller modules. In addition, different controllers or controller modules receive and transmit data with each other to make decisions and perform actions such that decentralized information processing takes place across the controllers 18.

The mowing deck 32 may include one or more inserts to reduce sound emissions. The inserts may be made of one or a combination of materials to deaden the sounds produced by the attachments on the mowing deck 32, including the implement motors 28. For example, the inserts may be made of one or a combination of various types of foam, rubber, Styrofoam, gels, etc. The mowing deck may further have one or more attachment rails to allow for other attachments to easily be added to the mower 10. In some embodiments, the attachment rail may be configured to include power and/or data connections, which may provide power to the additional attachments and/or communications to components on the mower 10, such as the controller 18. Example attachments may include blowers, vacuums, baggers, and the like.

In further embodiments, the mowing deck 32 may also have additional implement motors 28 for controlling other aspects of the mowing deck 32, such as the storage mode actuators, mowing deck 32 height adjustment devices, multi-directional discharge chute controls, etc. In some embodiments, the mower 10 may additionally have implement motors 28, such as seat adjustment motors, suspension control motors, etc.

In some embodiments, the mower 10 may include other features such as cup holders 34, adjustable seat 36, etc. In some embodiments, the cup holders 34 may be powered via the battery pack 100 and contain heating and/or cooling elements to allow for items placed in the cup holders 34 to be heated or cooled, respectively. In some embodiments, the adjustable seat 36 may be coupled to the battery pack 100 and configured to be adjusted via one or more electronic positioning devices. In still further embodiments, the adjustable seats 36 may include one or more heating or cooling elements, powered by the battery pack 100, to provide for operator comfort.

### Battery Pack

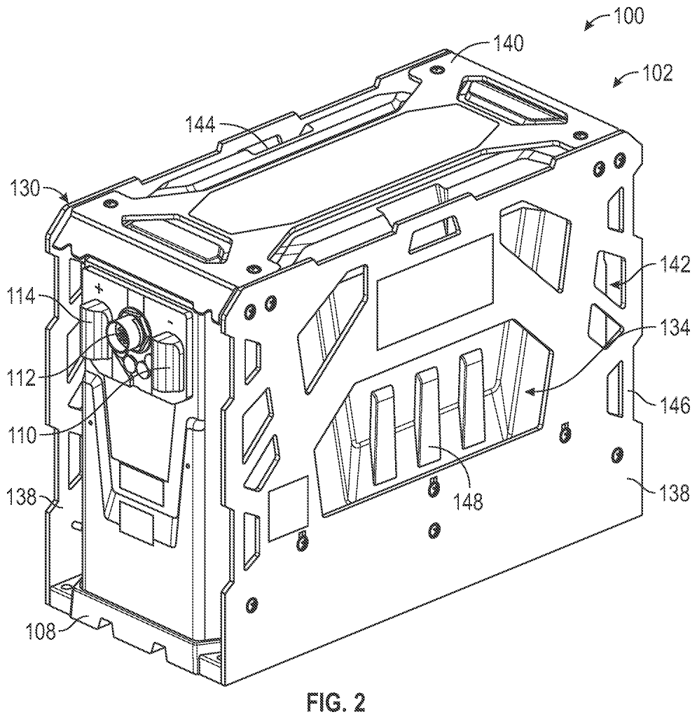

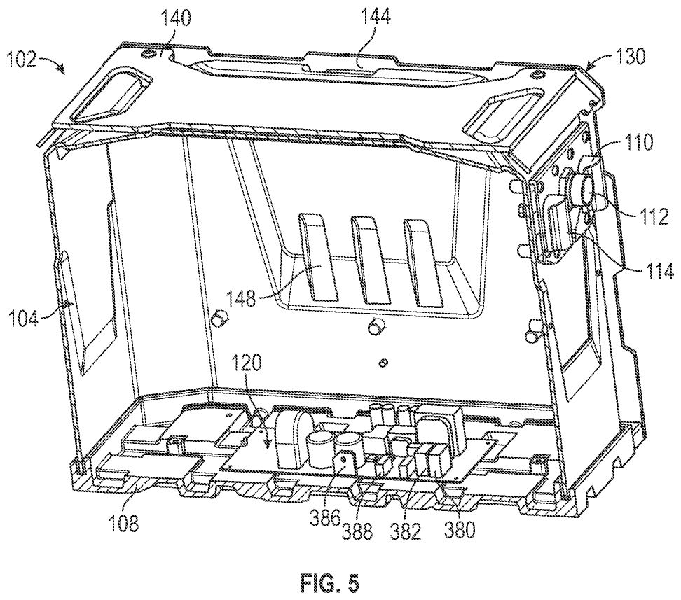

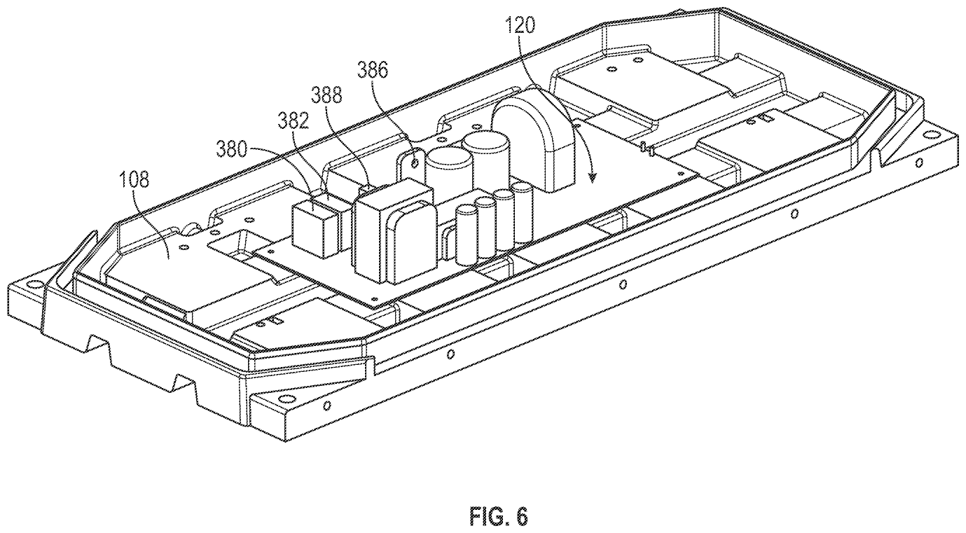

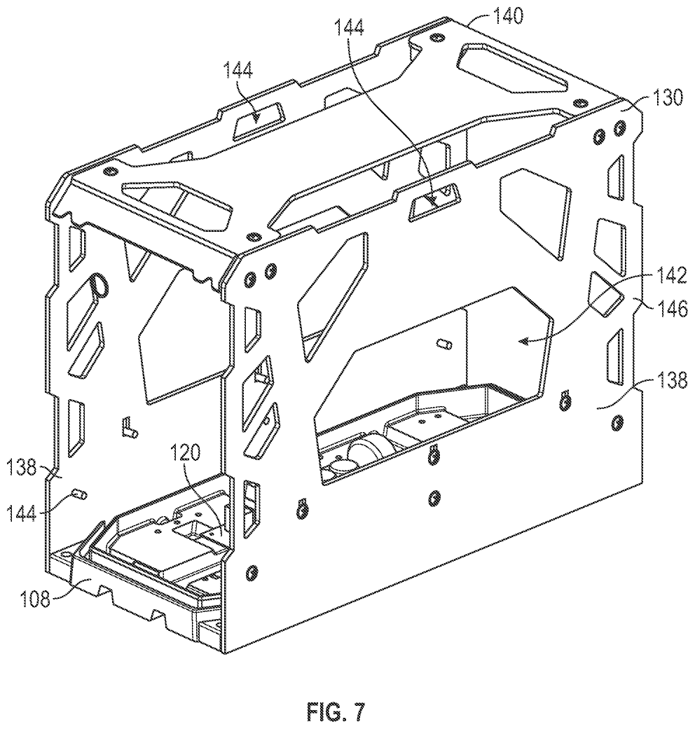

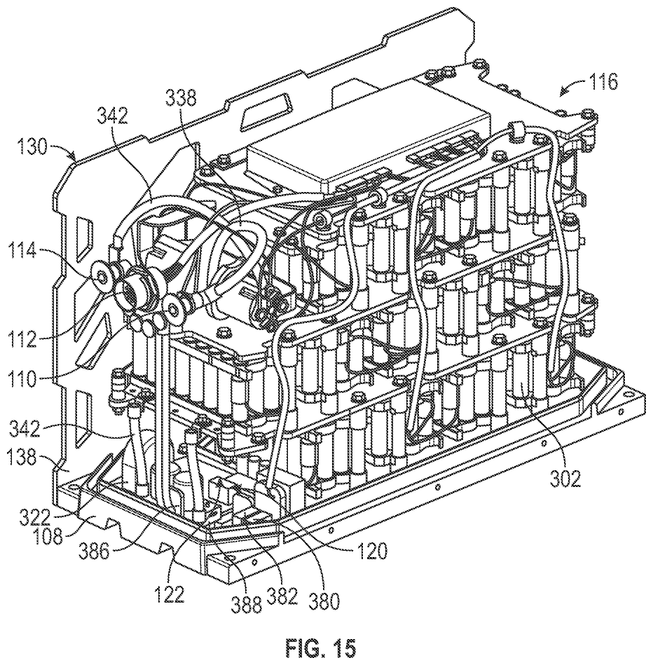

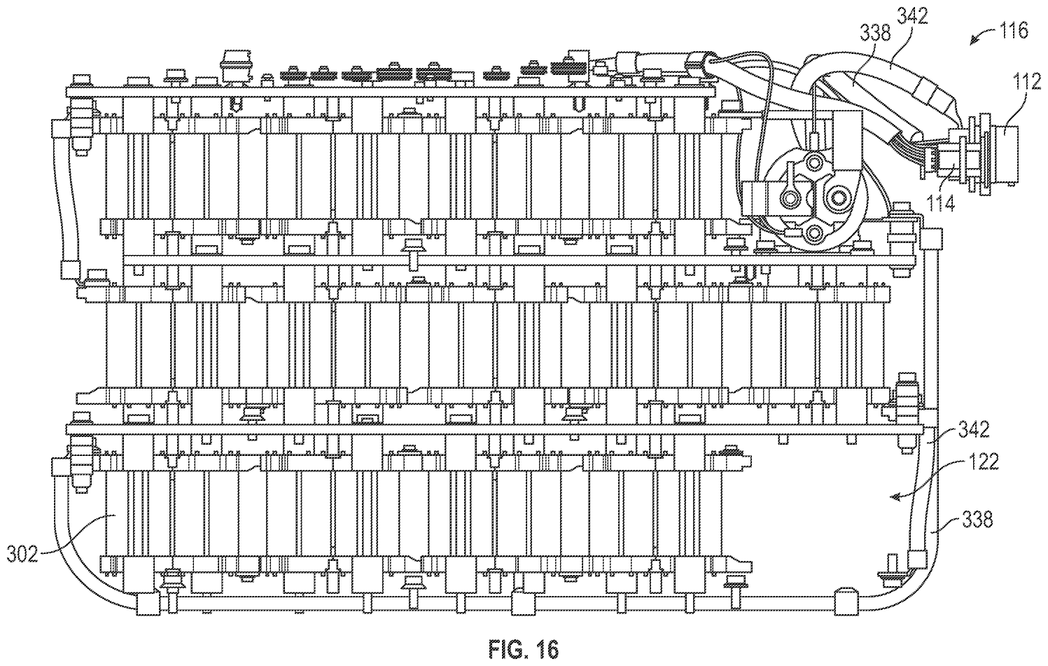

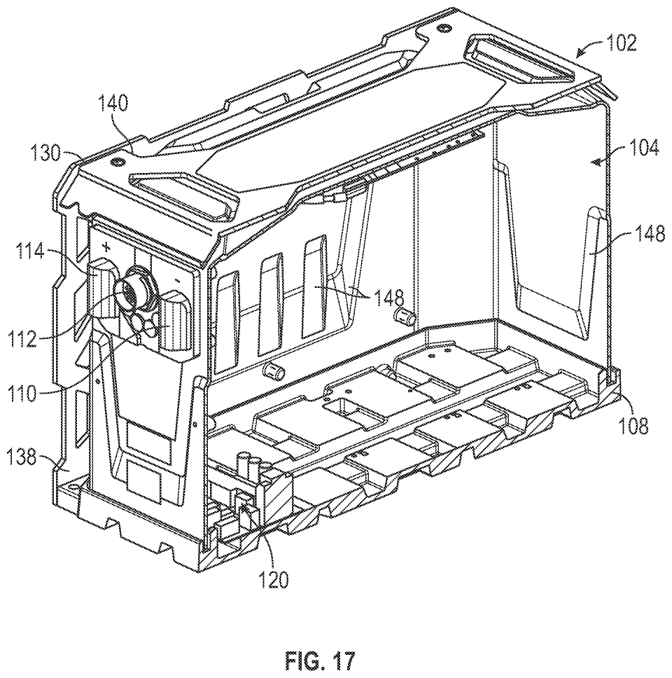

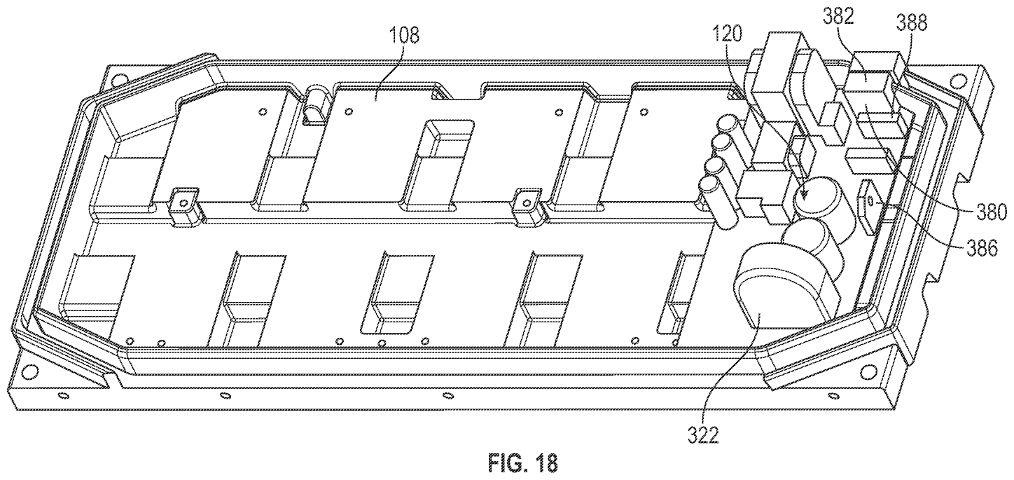

Referring to FIGS. 2-18, the battery pack 100 is a rechargeable battery (e.g., rechargeable battery, rechargeable battery bank, rechargeable battery array, rechargeable energy storage device, etc.), according to some embodiments. In some embodiments, the battery pack 100 may be a rechargeable battery, such as a Li-ion battery. However, other battery types, such as NiCd, lead-acid, Nickel-Metal Hydride (NiMH), or Lithium Polymer, are also contemplated. The battery pack 100 may be a lithium-ion battery comprising multiple Li-ion cells arranged in a variety of series(S) and parallel (P) configurations. In some embodiments, the battery pack 100 provides about one kilowatt-hour of energy (e.g., between 800 watt-hours and 1.2 kilowatt-hours). In some embodiments, the battery pack 100 is configured to be small enough, light enough, and graspable enough to allow the battery pack 100 to be manually portable by the user. In other embodiments, the battery pack 100 is not configured to be small enough, light enough, and graspable enough to allow the battery pack 100 to be manually portable by the user. For example, a user may need a lift, hoist, or other carrying device to move the battery pack 100. The battery pack 100 may be interchangeable between different pieces of equipment or chore products (e.g., between a lawn tractor, a vehicle, a backup power supply, a stand-alone power supply, a portable generator, a trolling motor, a golf cart, etc.).

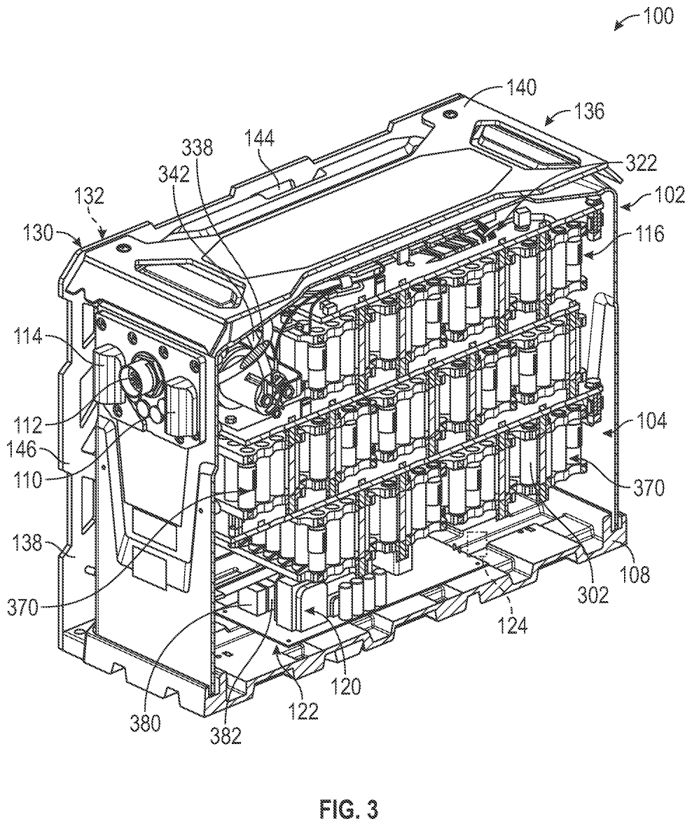

As shown in FIGS. 2-3, the battery pack 100 includes a housing 102. The housing 102 is an exterior enclosure for receiving and protecting the internal components of battery pack 100. For example, the housing 102 may define an interior cavity (e.g., interior space, interior volume, etc.), shown as interior cavity 104, which may house various electronic components of the battery pack 100. In some embodiments, some or all of the housing 102 may be made from a metal, polymer, or composite material. In some embodiments, the housing 102 may be fabricated from of a thermally conductive material (e.g., a material having a low thermal resistivity, a material having a thermal conductivity of at least approximately

$$80 \frac{W}{m K} @ 20 ° C . ,$$

1 ATM, a metal, aluminum, aluminum alloy, aluminum copper alloy, copper alloy, a non-metal thermal conductor such as graphite, etc.). In some embodiments, the housing 102 is fabricated from a material having a thermal conductivity this is at least approximately

$$100 \frac{W}{m K} @ 20 ° C . ,$$

1 ATM or at least approximately that is at least approximately

$$120 \frac{W}{m K} @ 20 ° C . ,$$

1 ATM to facilitate heat transport and cooling of the components within the housing 102. In some embodiments, the housing 102 is made of a material having a higher thermal conductivity when implemented to support a larger battery system (e.g., higher capacity, larger volume, heavier, higher power, etc.) where a material thickness of the housing 102 may be greater due to an increased load on the housing 102. In some embodiments, the housing 102 is made of a corrosion resistant and rigid material such as an aluminum alloy. In some embodiments, some or all of the housing 102 is made of metal formed via at least one of a casting process or drawing process (e.g., a deep drawing process).

In some embodiments, the housing 102 is coupled to and supported on a base 108 (e.g., bottom plate, base plate, bottom member, bottom support, etc.). In some embodiments, the housing 102 is a battery pack case that includes one or more removable components that permit easy access to one or more components in the interior cavity 104. In the illustrated embodiment, the battery pack 100 includes a negative terminal 110, a panel-mounted data connection terminal 112, and a positive terminal 114. In some embodiments, the negative terminal 110 and/or the positive terminal 114 extend through the housing 106 and are externally accessible relative to the housing 102. In some embodiments, the data connection terminal 112 is positioned between the positive terminal 114 and the negative terminal 110 on a common side of the housing 102. In other embodiments, the data connection terminal 112 is positioned elsewhere on the housing 102.

In some embodiments, the housing 102 is a single five-sided enclosure that covers a battery module assembly 116 (e.g., a cell module assembly (CMA) and a battery charger 120. In some embodiments, when the battery pack 100 is assembled, the CMA 116 is coupled to the base 108, and the housing 102 covers and seals the CMA 116 within the interior cavity 104 to prevent or inhibit water or debris from getting inside the battery pack 100. The housing 102 can be adaptable for a different size and capacity of the CMA 116. In some embodiments, the housing 102 of the battery pack 100 includes a user interface. For example, the battery pack 100 may include a display, button, camera, microphone, speaker, or other interface configured to facilitate an interaction between the battery pack 100 and a user of the battery pack 100 by presenting and/or receiving data regarding the battery pack 100.

In some embodiments, the panel-mounted data connection terminal 112 of the battery pack 100 may provide protection for short-circuiting the positive terminal 114 and the negative terminal 110 of the battery pack 100. The panel-mounted data connection terminal 112 may also include poka-yoked pins for controlling different current capacities in the single connector. In some embodiments, the poka-yoked pins prevent the coupling of incorrect components to the panel-mounted data connection terminal 112.

In some embodiments, the positive terminal 114 may be or include one or more terminals and the negative terminal 110 may be or include one or more terminals. In some embodiments, the positive terminal 114 and the negative terminal 110 may be situated near an electrical ground. For example, the positive terminal 114 and negative terminal 110 may facilitate a user attaching a device via a connector having one or more plug arrangements (e.g., two prong plugs, three prong plugs, Type-D, Type-F, Type-C, Type-D, Type-I, Type-L, Type-H, Type-E, Type-B, Type-G, Type-A, Type-K, type plugs, Anderson plugs, proprietary plug types, etc.). In some embodiments, positive terminal 114 and negative terminal 110 may facilitate an electrical coupling with one or more external devices (e.g., a power output device, a power input device, a power storage device, etc.). For example, the positive terminal 114 may couple with a connector or end of a cable of an external device. Such external devices may be or include another battery pack 100, electrically-operated outdoor power equipment, a chore product, a motor, a computer, a user device, a cellphone, an electrically drive system, etc.), a power input device (e.g., a solar panel, a wind power generator, a generator), a utility power supply (e.g., a mains power supply, etc.). In some embodiments, the battery pack 100 includes one or more dedicated positive terminals 114 and a negative terminals 110 for attaching a one or more corresponding external devices.

In some embodiments, the battery pack 100 is configured to receive and/or supply at least one of AC power or DC power. For example, the battery pack 100 may receive at least one of AC power via AC input terminals (e.g., via a connection to the grid, via a connection to an AC power supply, via a connection to a power station etc.), receive DC power via DC input terminals (e.g., via a connection to a non-inverted solar power supply, via a connection to a DC output of another battery pack 100, via a connection to a DC power supply, etc.), supply AC power via AC output terminals (e.g., via a connection to the CMA 116 through a DC to AC converter), and/or supply DC power via the negative terminal 110 and the positive terminal 114 (e.g., via a connection to the CMA 116). In some embodiments, the battery pack 100 is configured to supply power either partially or entirely based on energy stored in the interior cavity 104. For example, the battery pack 100 may be configured to selectively access energy stored in the CMA 116 to achieve a target output characteristic (e.g., a target power characteristic) at the output of the battery pack 100 (e.g., the negative terminal 110 and the positive terminal 114).

In some embodiments, the battery pack 100 may facilitate pass-through charging, and/or may be configured to perform AC to DC and/or DC to AC power conversion for one or more power supplies connected to the battery pack 100. For example, the battery pack 100 may receive a DC power supply from a solar power supply and subsequently convert the DC power to AC power (e.g., via an inverter), and the resulting AC power may be supplied directly to an output terminals of the battery pack 100 (e.g., via AC output terminals). In some embodiments, excess power (e.g., input power exceeding the output power) may be applied to the CMA 116 to facilitate charging the CMA 116. In some embodiments, when the CMA 116 is full or charging at a limited rate, the battery pack 100 is configured to dissipate some or all of the excess power as heat. In some embodiments, the charger 120 is configured to perform AC to DC power conversion and power monitoring and regulation, as described in greater detail below.

Referring to FIGS. 3-7, the base 108 includes the battery charger 120 (e.g., a recharger, a battery controller, a power controller, a battery management system, a battery manager, a charge manager, a charge controller), within the interior cavity 104. The charger 120 may be configured to supply energy to the CMA 116 based on an electric current running through at least a portion of the charger 120. In some embodiments, the charger 120 is configured to receive and/or supply at least one of AC power or DC power. For example, the charger 120 may receive at least one of AC power via AC input terminals (e.g., via a connection to the grid, via a connection to an AC power supply, via a connection to a power station, etc.), receive DC power via DC input terminals (e.g., via a connection to a non-inverted solar power supply, via a connection to a DC output of another battery pack 100, via a connection to a DC power supply, etc.), supply AC power via AC output terminals (e.g., via a connection to the CMA 116 through a DC to AC converter such as an inverter), and/or supply DC power via DC output terminals (e.g., via a connection to the CMA 116). In some embodiments, the charger 120 is configured to receive AC power or DC power and selectively supply DC power to the CMA 116. In some embodiments, the charger 120 is configured to supply power to the output terminals (e.g., the negative terminal 110 and the positive terminal 114) either partially or entirely based on energy stored in the interior cavity 104 (e.g., within the CMA 116).

In some embodiments, the charger 120 may regulate the power available at one or more terminals of the battery pack 100. For example, the charger 120 may limit the power output such that the quantity of power available at the outlet terminals complies with one or more threshold values. For example, excess power at the power inlet may be applied to the CMA 116 to facilitate charging the CMA 116, and/or may be dissipated as heat. In some embodiments, excess power at the power inlet may be attributed to a supply power exceeding an output power limit (e.g., a power surge), a supply power exceeding the charge capacity (e.g., C-rate) of the CMA 116, and/or a supply power exceeding a demand attributed to the power outlet.

In some embodiments, the charger 120 may facilitate pass-through charging (e.g., simultaneous charging and discharging of the CMA 116), and/or may be configured to perform AC to DC and/or DC to AC power conversion for a power input to the battery pack 100. For example, the battery pack 100 may receive a DC power supply from a solar power supply and subsequently convert the DC power to AC power (e.g., via an inverter and one or more power filtering devices), and the resulting AC power may be supplied directly to the output terminals of the battery pack 100. In such example, the supply power (e.g., power input to the charger 120), may be supplemented by power from the CMA 116, and thereby yield an increased power output to the demanded output.

In some embodiments, the charger 120 is at least partially integrated into and/or supported on the base 108. The charger 120 may be coupled to the base 108 by at least one of a fastener, adhesive, weld, bond, thermally conductive material, or other suitable coupler such that at least a portion of thermal energy generated by the charger 120 is conductively transported into the base 108. In some embodiments, the charger 120 is coupled to the base 108 such that some or most of the components of the charger 120 are thermally coupled with the base 108. For example, during operation of the charger 120, components of the charger 120 may generate heat (e.g., intentionally generate heat by powering one or more resistive devices or unintentionally generate heat due to inefficiencies of electrical devices), and the heat may be transferred into the material of the base 108. In this way, the base 108 may thermally stabilize at least a portion of the charger 120.

In some embodiments, the charger 120 is at least partially integrated into the housing 102. The charger 120 may be coupled to (e.g., fastened to, adhered to, press fit into,) the housing 102 such that at least a portion of thermal energy generated by the charger 120 is conductively transported into the housing 102 (e.g., the coupling doesn't include a thermal insulator that substantially prevents thermal energy from being transferred between the charger 120 and the housing 102). For example, during operation of the charger 120, various components of the charger 120 may generate heat and the generated heat may be deposited into the material of the housing 102. In this way, the housing 102 may thermally stabilize at least a portion of the charger 120.

Referring specifically to FIG. 3, the charger 120 is mounted within a portion of the interior cavity 104 defined between the CMA 116 and the base 108, shown as gap 122. The housing 102 and the CMA 116 may be sized and shaped to accommodate a gap 122 that causes the CMA 116 to be spaced from the charger 120. In other words, the charger 120 may be arranged below the CMA 116 and the housing 102 may be dimensioned (e.g., increased in height when compared to a housing that doesn't house a charger and a CMA) to accommodate both the charger 120 and the CMA 116 mounted above the charger 120.

In some embodiments, when the battery pack 100 is in an assembled and normal operating position (e.g., as shown in FIG. 2), the base 108 is gravitationally lower than the housing 102. In some embodiments, the base 108 may be gravitationally lower than at least a portion of the CMA 116. In such embodiments, the housing 102 may include proportionately larger surfaces extending substantially parallel to the gravitational vector, such that natural convection is promoted.

The base 108 extends underneath at least a portion of the CMA 116. The base 108 may have a footprint that is the same or larger than a footprint of the CMA 116. In some embodiments, at least a portion of the CMA 116 may be mounted such that the CMA 116 sits gravitationally higher than the base 108. In some embodiments, the housing 102 includes a rim, and the interface between the rim and the base 108 is substantially planar. In some embodiments, the base 108 includes one or more grooves, slots, ribs, and/or other suitable features configured to facilitate a seal with the rim of the housing 102. In some embodiments, a sealant (e.g., silicone, etc.) may be applied along the interface between the housing 102 and the base 108 to promote or enable a seal.

In some embodiments, the gap 122 is at least partially enclosed from the remainder of interior cavity 104 by a wall 124. In some embodiments, the wall 124 may shield the charger 120 from other components within the interior cavity 104. In some embodiments, the wall 124 facilitates an exchange of fluid (e.g., gas, air, etc.) between the gap 122 and the remainder of the interior cavity 104. In other embodiments, the wall 124 seals the gap 122 from the remainder of the interior cavity 104 such that an exchange of fluid between the gap 122 and the remainder of the interior cavity 104 inhibited by the wall 124. In some embodiments, the wall 124 electrically shields, magnetically shields, and/or thermally shields the charger 120 from some or all of the components of the battery pack 100 within the interior cavity 104.

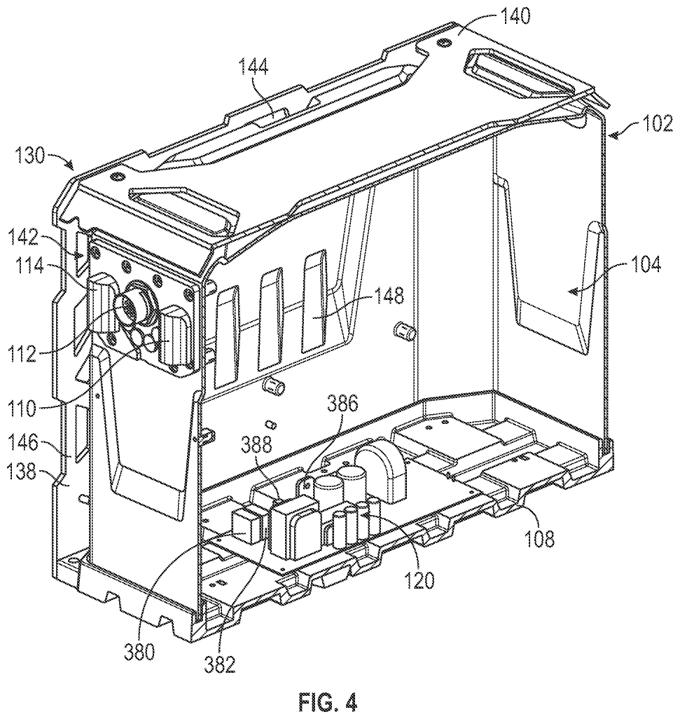

Referring to FIG. 4, the charger 120 may be partially or entirely on a single board (e.g., a PCB board or electrical board). For example, the charger 120 may be or include one or more electrical circuits configured as a system on a chip, and some or all of which may be embedded on or into a charging board. In some embodiments, the charger 120 includes one or more input terminals and one or more output terminals coupled to terminals within the interior cavity 104 or extending through the housing 102 (e.g., positive terminal 114, negative terminal 110). In some embodiments, the charger 120 may include AC input terminals, DC input terminals, AC output terminals, and/or DC output terminals. In some embodiments, the charger 120 includes AC input terminals and DC input terminals electrically coupled to terminals extending through the housing 102 (e.g., positive terminal 114, negative terminal 110), DC input terminals coupled to the CMA 116 within the interior cavity 104, DC output terminals coupled to the CMA 116 (e.g., configured to output power to the CMA 116 to charge the CMA 116), AC output terminals and DC output terminals electrically coupled to terminals extending through the housing 102 (e.g., positive terminal 114, negative terminal 110).

In some embodiments, the charger 120 may be configured to provide various charging profiles suitable for charging the CMA 116. For example, the charger 120 may apply the same or different charging profiles for CMAs 116 of various sizes, capacities, compositions, and ages, and may be configured to implement new or conventional charging strategies (e.g., trickle charging, pre-charging, constant current charging, constant voltage charging, charge termination charging, etc.) to accommodate the current state of the battery pack 100. In some embodiments, the charger 120 may be configured to detect a state of the CMA 116 by obtaining information regarding at least a portion of the CMA 116 (e.g., age, configuration, chemical composition, setting, arrangement, manufacturer specification, capacity, temperature, nominal voltage, nominal current, historical operation data, etc.) and/or by obtaining information regarding of one or more connected devices (e.g., at least a portion of an external CMA 116 electrically coupled to the battery pack 100, a solar charger, an amperage draw, etc.). In some embodiments, the battery pack 100 may be electrically coupled (e.g., by jumper cables, by one or more suitable electrical conductive devices, etc.) to one or more other battery packs, and the charger 120 may be configured to charge, manage, and maintain the one or more electrically coupled other battery packs.

In some embodiments, the battery pack 100 may optionally be provided as a kit including the battery pack 100 along with one or more additional energy storage devices. In such embodiments, the additional energy storage device (e.g., external battery, standalone battery pack, extra battery pack 100, etc.) may be monitored and maintained by the charger 120 of the battery pack 100 a connection to the charger 120 (e.g., via the a connection through the positive terminal 114, data terminal 112, and/or negative terminal 110). In some embodiments, the additional energy storage device may be configured to rely on charger 120 for charging. In some embodiments, the charger 120 may supplement or provide power at output terminals of the battery pack 100 by accessing energy stored in the additional energy storage device.

Referring now to FIGS. 2, 3, and 7, the housing 102 includes a frame 130 partially enclosing the housing 102. The frame 130 may be a rigid structure that provides support for a mechanical load (e.g., force) applied to the battery pack 100. For example, the frame 130 may be made of metal (titanium, aluminum, steel, etc.), a metal alloy, a composite material, a polymer, or any combination thereof, and may be coupled to the base 108 via one or more permanent (e.g., fusing, welding, riveting, etc.) or non-permanent coupling techniques (e.g., fasteners, locking mechanisms, etc.).

In some embodiments, the frame 130 is coupled to the base 108 and surrounds the housing 102 on at least three sides of the housing 102. For example, the frame 130 may extend around a right side 132, a left side 134, and a top side 136 of the housing 102. In some embodiments, the frame 130 is an assembly of two or more components that are formed separately and then joined together. The frame 130 may include walls 138 joined together by a top plate 140. The frame 130 may be formed of a thermally conductive material (e.g., a material having a low thermal resistivity). In this way, thermal energy may be transferred between the base 108 and the frame 130.

In some embodiments, the frame 130 includes one or more weight reducing features (e.g., holes, cutouts) shown as cutouts 142, mounting features (e.g., mounting points, anchor points, tie down points, crane attachment points, hoist points, eyelets, etc.) shown as mounts 144, and one or more cooling features (e.g., fins, ribs, pins) shown as fins 146. In some embodiments, the frame 130 is sufficiently thick and rigid to protect the housing 102 from an impact (e.g., due to an other object colliding with the battery pack 100). In some embodiments, the housing 102 has a proportionately thin wall thickness compared to the thickness of the base 108 and/or frame 130. The frame 130 may be configured to endure forces that would otherwise be applied to the housing 102 (e.g., a weight an object stacked on top of the battery pack 100, an impact from an object, etc.). In this way, the frame 130 may protect the housing 102 from loads that may otherwise cause deformation of the housing 102 that may damage components within the interior cavity 104, and/or break the seal of the housing 102 with the base 108.

In some embodiments, the one or more walls 138 of the frame 130 are tapered inward toward a top portion 152 of the housing 102, and the base 108 defines a larger footprint than the housing 102. In some embodiments, the frame 130 may be a free floating around the housing 102. For example, the frame 130 may surround the housing 102 without touching or otherwise contacting the housing 102 and may be entirely supported by the base 108.

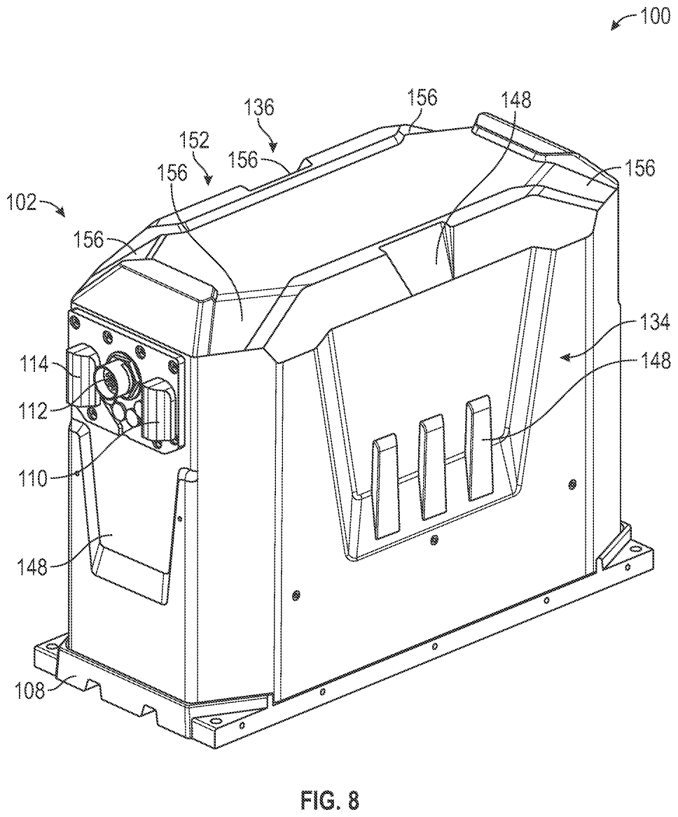

Referring to FIG. 8, the housing 102 has a thickness and structural rigidity such that the housing 102 can support various loads (e.g., impacts, weights, etc.) and the frame 130 is not included. The housing 102 may be made from a metal sheet via a deep drawing process. In some embodiments, the housing 102 includes stiffening features (e.g., ribs, corrugation, bosses, etc.), shown as ribs 148, that enhance the rigidity of the housing 102. In some embodiments, the ribs 148 may include one or more bosses or structures configured to promote convective heat transfer.

In some embodiments, the housing 102 includes drainage features (e.g., channels, groves, fluid conduits, etc.) configured to direct fluid and/or debris away from the housing 102. For example, the housing 102 may include one or more channels 156, configured to prevent a fluid (e.g., water) or debris (e.g., dust, dirt, grass clippings, etc.) from accumulating on a surface of the housing 102. The channels 156 may be gravitationally lower than an accumulation point (e.g., a gravitationally lowest point of a concave surface) and may extend in a gravitationally downward direction such that fluid and/or debris are influenced into and through the channels 156 by gravity. In some embodiments, a user may utilize the channels 156 to easily remove debris (e.g., a layer of dirt or grass clippings that prevent a heat exchange between ambient air and the outer surface of the housing 102) that would otherwise thermally insulate the housing 102.

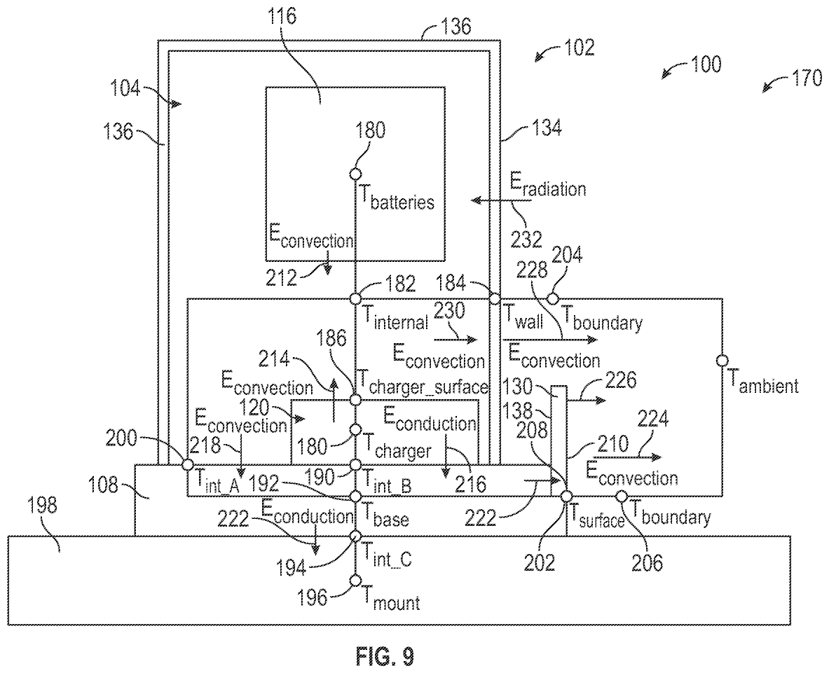

Referring to FIG. 9, a thermodynamic model of the battery pack 100 is illustrated as model 170. The model 170 is a simplified model according to various thermodynamic assumptions about the battery pack 100. In some embodiments, the charger 120 may utilize model 170 to make control decisions. For example, the charger 120 may determine an energy or power to apply to a heating device (e.g., resistor, resistive strip, ceramic heater, etc.) to achieve one or more target temperature values of the battery pack 100 (e.g., according a control logic of the controller). It is important to note that the thermodynamic model utilized by the charger 120 may have a greater complexity than shown in model 170, and may involve additional or different thermodynamic considerations and modeling techniques. For example, enthalpy, (or alternatively extropy), is not detailed in model 170, and transient and non-uniform internal characteristics are not detailed in model 170. Additionally, the housing 102, is assumed to have a Biot number less than 0.1, for purposes of illustration. As such, the housing 102 is modeled as a body having a uniform temperature. In some embodiments, the housing 102 does not have a Biot number less than 0.1, and the temperatures inside the housing 102 experiences significant variance. Additionally, the model 170 illustrates various lumped-component assumptions (e.g., a lumped-capacitance) for several components of the battery pack 100.

Referring to FIG. 9, the battery pack 100 is configured such that the battery pack 100 can be thermodynamically modeled as a closed system during operation of the battery pack 100. For example, because the housing 102 is sealed to the base 108, the interior cavity 104 is sealed from the ambient environment (e.g., by the housing 102). So, mass transport between the interior cavity 104 and the ambient environment is negligible, and accordingly, advection is modeled as being negligible (zero). In some embodiments, the external surfaces of the battery pack 100 (e.g., the outer surface of the housing 102 and base 108, optionally also the outer surface of the frame 130) may represent a thermodynamic boundary of the battery pack 100. The thermodynamic boundary can be used as a basis defining equilibrium (e.g., a mass balance, an energy balance), which can facilitate a determination of one or more unknown variables of the model 170 (e.g., a temperature value, a heat transfer coefficient, an energy value, a target heat rate, etc.). In some embodiments, the housing 102 may be structured such that the thermodynamic boundary of the battery pack 100 can be assumed to have a fixed mass (sealed) and a fixed volume (e.g., the housing 102 and base 108 are substantially rigid), for common applications of the battery pack 100.

The model 170 may include various temperature nodes, illustrated as temperature 180 of the CMA 116, temperature 182 of the fluid within the interior cavity 104 (e.g., the bulk temperature of the air, gas, etc.), a temperature 184 of the housing 102, a temperature 186 of the interface between the charger 120 and the interior cavity 104, a temperature 188 of the interior of the charger 120, a temperature 190 of the interface between the charger 120 and the base 108, a temperature 192 of the interior of the base 108, a temperature 194 of the interface between the base 108 and an object 198 the battery pack 100 is mounted onto, a temperature 196 of the object 198, a temperature 200 of the interface between the fluid of the interior cavity 104 and the base 108, a temperature 202 of the interface between the ambient environment and the base 108, a temperature 204 of a boundary layer between the housing 102 and the ambient environment, a temperature 206 of the boundary layer between the base 108 and the ambient environment, a temperature 208 of the frame 130, and a temperature 210 of a boundary layer between the frame 130 and the ambient environment. Some or all of the temperatures 180, 182, 184, 186, 188, 190, 192, 194, 196, 198, 200, 202, 204, 206, 208, 210 may be obtained by the charger 120 via measurement (e.g., by one or more temperature sensors), or may be approximated based on a combination of thermodynamic differential equations and equilibrium models (e.g., mass balances, energy balances).

The model 170 illustratively includes energy flows, shown as convective energy transport 212 between the CMA 116 and the fluid within the interior cavity 104, convective energy transport 214 between the charger 120 and the fluid within the interior cavity 104, conductive energy transport 216 between the charger 120 and the base 108, convective energy transport 218 between the fluid within the interior cavity 104 and the base 108, conductive energy transport 220 between the base 108 and the object 198, conductive energy transport 222 between the base 108 and the frame 130, convective energy transport 224 between the base 108 and the ambient environment, convective energy transport 226 between the frame 130 and the ambient environment, convective energy transport 228 between the housing 102 and the ambient environment, convective energy transport 230 between the fluid within the interior cavity 104 and the housing 102, and radiative energy transport 232 between the housing 102 and a source (e.g., the sun).

The conductive energy transports (e.g., conductive energy transport 216, conductive energy transport 222, etc.) may be modeled according to Fourier's Law. For example, the conductive energy transport may be modeled as:

$${q}_{conduction} = - k ∇ T$$

where q is the local heat flux density, k is the material's conductivity, and VT is the temperature gradient (e.g., the temperature gradient between the illustrative temperature nodes of model 170).

The convective energy transports (e.g., convective energy transport 224, convective energy transport 226, etc.) may be modeled according to Newton's Law of Cooling. For example, the convective energy transport may be modeled as:

$${q}_{convetion} = h A ( {T}_{s} - {T}_{∞} )$$

where q is the heat transfer out of the body, h is the heat transfer coefficient, A is the heat transfer surface area, Tₛ is the temperature of the object's surface, and T_{∞} is the temperature of the ambient environment. The heat transfer coefficient, h, may account for an assortment of fluid properties including transport properties (e.g., viscosity of the fluid, thermal diffusivity of the fluid, etc.), geometry of the object's surface, and the nature of the flow over the surface (e.g., laminar, turbulent, etc.). One or more of the convective heat transports may determine values associated with a boundary layer (e.g., temperature 208, temperature 204). The values of the coefficients of the convective heat transports (e.g., the heat transfer coefficient, h), may have values obtained by various approximation and engineering techniques (e.g., finite element analysis, numerical fluid dynamics, empirical relationships, numerical methods, simulations, etc.) that facilitate a determination of appropriate values for use in the model 170. Such determination may involve a determination of various dimensionless terms (pi-terms), such as a Reynolds number, a Prandtl number, a Nusselt number, a Biot number, a Grashof number, and/or a Rayleigh number. In some embodiments, the battery pack 100 is configured to maintain one or more temperature limits by estimating the maximum heat transport to the ambient environment under natural convection assumptions (e.g., where no fluid flow is being forced to move along the surfaces of the housing 102 and/or frame 130).

In some embodiments, the radiative energy transport (e.g., radiative energy transport 232) may be modeled according to the Stefan-Boltzmann Law. For example, the radiative energy transport may be modeled as:

$${q}_{radiative} = ϵ σ {T}^{4} A$$

where q is the heat transfer rate, σ is the Stefan-Boltzmann Constant

$$( i . e . , 5.6703 * {10}^{- 8} \frac{W}{{m}^{2} {K}^{4}} ) ,$$

A is the area of the emitting body, Tis the temperature, and e is the emissivity coefficient of the object. The value of the coefficients of the radiative heat transports (e.g., the emissivity, ϵ), may have values obtained by various approximation and/or engineering techniques (e.g., finite element analysis, numerical fluid dynamics, empirical relationships, numerical methods, simulations, etc.) that facilitate a determination of appropriate values for use in the model 170.

The energy transports 212, 214, 216, 218, 220, 222, 224, 226, 228, 230, 232 illustratively include arrows that may represent the direction of energy flows according to a state of the system. In other embodiments, the direction of one or more energy transports 212, 214, 216, 218, 220, 222, 224, 226, 228, 230, 232 may be in an opposite direction than shown. For example, the direction of the arrows represent a state of the battery pack 100 where the charger 120 has an elevated temperature (e.g., a relatively higher temperature 188), than the base 108 (e.g., temperature 192), the fluid within the interior cavity 104 (e.g., temperature 182), the housing 102 (e.g., temperature 184), the object 198 (e.g., temperature 196), and the ambient temperature. Further in such example, the CMA 116 has an elevated temperature (e.g., a relatively higher temperature 180) than the fluid within the interior cavity 104 (e.g., temperature 182). In other words, in this example, the arrows of the transports point toward the direction of the descending temperature gradient between the points (e.g., temperature nodes) in the model 170 (e.g., temperatures 180, 182, 184, 186, 188, 190, 192, 194, 196, 198, 200, 202, 204, 206, 208, 210). Such example may illustrate a situation where the battery pack 100 is powered (e.g., turned on, receiving energy into the charger 120), and the charger 120 and CMA 116 are dissipating heat.

In some embodiments, the heat generated by the charger 120 and/or CMA 116 may be transferred into the local environment of the charger 120 and the CMA 116. For example, heat generated by the charger 120 may be transferred into the base 108 and the fluid within the interior cavity 104. In some embodiments, the local environment (e.g., an environment proximate the CMA 116 and the charger 120 within the interior cavity 104) is below a temperature threshold for performing one or more functions of the CMA 116 and/or charger 120. In such embodiments, the charger 120 may direct power into a heating device (e.g., a resistive heating device, a resistor bank, etc.) to heat the battery pack 100 (e.g., heat the interior cavity 104). For example, when the ambient environment is below freezing (e.g., during seasonal weather, etc.) the charger 120 may determine that the temperature of the battery pack 100 (e.g., within the interior cavity 104) is below a threshold value for the temperature. The charger 120 may, in response to the determination, direct energy into a heating element of the battery pack 100, to thereby heat at least a portion of the battery pack 100. For example, the base 108 and/or the housing 102 may include one or more resistive elements coupled to or embedded within the material that, when powered, are configured to dissipate electrical energy as heat. In some embodiments, the resistive elements coupled to or embedded within the material of the housing 102 and may heat at least a portion of the housing 102 (e.g., the base 108, the housing 102) such that the heat is diffused within the material and thereby facilitates a dispersed and relatively steady heating of the battery pack 100.

In some embodiments, when some or all of the local environment has a same or higher temperature than the CMA 116 and/or the charger 120, the battery pack 100 may be configured to diffuse heat from the local environment throughout the battery pack 100 such that thermodynamic equilibrium is maintained within the battery pack 100.

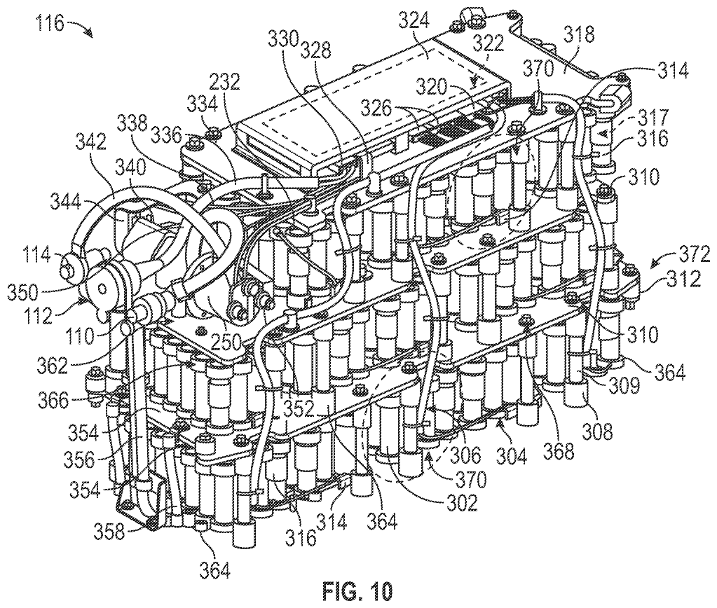

Referring to FIGS. 10-12, the CMA 116 is shown in additional detail, according to some embodiments. The CMA 116 includes a top plate 318, midplates 310, an anti-rack plate 334, spacers 309, harness cutouts 306, and mounting hardware 368. In some embodiments, the top plate 318 and the midplates 310 (which are positioned between the top plate 318 and a base plate at the bottom of the CMA 116) are made out of aluminum. Each plate 310, 318 may contain several harness cutouts 306 to help the routing of the cables throughout the interior cavity 104 of the battery pack 100. The harness cutouts 306 may be used to retain the wire harnesses of the CMA 116. Further, the harness cutouts 306 in the plates of the battery pack 100 allow wires to run between tiers without the expansion of the form factor of battery pack 100. The battery pack 100 may be constructed using a series of lip seals with tie down rails and latches.

The CMA 116 may include multiple CMA sections 370 vertically positioned in tiers, where a first tier positioned directly above a second tier, and a third tier positioned above the second tier. Each CMA section 370 includes a top CMA cell holder frame, a bottom CMA cell holder frame, a top collector plate (e.g., the positive collector plate 366), a bottom collector plate (e.g., the negative collector plate 354), multiple battery cells 302, and curable adhesive to couple the battery cells 302 to the top of the CMA cell holder frame and the bottom CMA cell holder frame. The CMA sections 370 may be spaced apart from one another and positioned between the midplates 310, a midplate 310 and a top plate 318, and/or the bottom midplate 310 and the base 108 of the battery pack 100. Each tier of the CMA 116 can include two midplates 310 and several CMA sections 370. In some embodiments, the midplates 310 are positioned between the positive terminals of the battery cells 302 of the CMA sections 370 within the CMA 116.

In some embodiments, the CMA 116 is assembled such that there are gaps between the battery cells of each CMA section 370 and a plate (e.g., the top plate 318, midplates 310, housing 102, base 108, the wall 124). These gaps between the battery cells 302 of the CMA sections 370 and the plates in each tier of the battery pack may prevent damage to the CMA 116 during thermal events. Beneficially, when heat is dissipated from a bad battery cell, the likelihood of the thermal event cascading (e.g., a thermal runaway) to the other battery cells 302 and causing more damage to the components of the CMA 116 is reduced.

The mounting hardware 368 may include fasteners that are easily serviceable with tools such as wrenches. In addition to the mounting hardware 368 used throughout the battery pack 100 providing structure and stability for the battery pack 100, the mounting hardware 368 may provide thermal conductivity along all structural components, plates, spacers, etc. of the battery pack 100. The spacers 309 between all of the tiers of the CMA 116 may include compression limiters 308. The compression limiters 308 may be steel or aluminum and are adapted to provide a thermally conductive path, while still maintaining electrically independent tiers, through the tiers of the battery pack 100.

In some embodiments, a thermistor 317 may be coupled to one of the battery cells 302 within a CMA section 370 of the battery pack 100. In some embodiments, the thermistor 317 is secured to a battery cell 302 with tape 316. In some embodiments, closed cell foam adhesive is used to mount the thermistors 317 to the battery cells 302. Each CMA section 370 within the battery pack 100 includes one thermistor 317 to monitor the temperature of that individual CMA section 370. The CMA 116 may also include a resistive heating strip on the plates for uniformly heating the battery pack 100. In some embodiments, each tier has a resistive heating strip that runs at a different heating capacity than the heating strips on the other tiers. The resistance of the resistive heating element may change based upon its own temperature. For example, the variable resistance of the heating elements may be based on the temperature of the heating element. As such, when a certain area of CMA 116 is determined to be at a higher temperature than the rest of the CMA 116 (e.g., the top tier of the battery pack is near a component of outdoor power equipment that produces a lot of external heat), the resistive heating element near that area may have a lower heating level than other resistive heating elements in the battery pack 100. For example, the top tier of the battery pack 100 may have a resistive heating element at a lower wattage than a resistive heating element on a lower tier, such as the bottom tier of the battery pack 100. The resistive heating strips and thermistors 317 can communicate with the charger 120 to control the temperature within the battery pack 100.

In some embodiments, a tier of the battery pack 100 may include more resistive heating elements than a different tier. In some embodiments, the resistive heating elements may have positive or negative coefficients to increase the capability of the battery pack 100 to be thermally self-regulated. In some embodiments, the charger 120 may receive and/or supply external power to run one or more heating elements (e.g., the resistive heating strips) using the existing external terminals of the housing 102. As such, the temperature of the battery pack 100 (e.g., the interior cavity 104, the charger 120, the CMA 116, the housing 102, etc.) may be increased above a threshold temperature level without any current flowing into or out of the battery pack 100 and the battery cells 302. In some embodiments, an internal circulating fan helps create a uniform internal temperature for the battery pack 100 without exchanging air outside of the housing 102 of the battery pack 100.

Advantageously, by creating a more uniform temperature level inside the housing 102, the battery pack 100 may avoid a particular area of the battery pack 100 having a much higher temperature than the other components of the battery pack 100.

Each CMA section 370 of the battery pack 100 includes multiple battery cells 302, which can together output power to operate a vehicle or other equipment, such as mower 10. In some embodiments, the battery cells 302 are lithium-ion battery cells. The battery cells 302 can be lithium-ion battery cells rated at 3.6 volts and 3 amp-hours, for example. As illustrated, each of the fourteen CMA sections 370 include thirty-two battery cells 302 arranged in four rows of eight cells each. The battery cells 302 are electrically connected to one another using conducting wires having terminals coupled (e.g., wire bonded) to each battery cell 302 and a common conductor (e.g., a positive collector plate 366 or negative collector plate 354).

In some embodiments, the CMA 116 includes a battery management system 322 for regulating the currents and/or voltages involved in the charging and discharging processes in order to ensure that the battery cells 302 are not damaged or otherwise brought to problematic charge states. In some embodiments, some or all of the functionality and structure of the battery management system 322 is integrated into the charger 120. The battery management system 322 may block an electrical current from being delivered to the battery cells 302, or may block a current being drawn from the battery cells 302 based on the current and voltage properties of the CMA section 370. The battery management system 322 may also implement controls based on a temperature as detected by a temperature sensor (e.g., thermistor 317) and regulate operation of the CMA sections 370 based on over temperature or under temperature conditions determined by the detected temperature received.

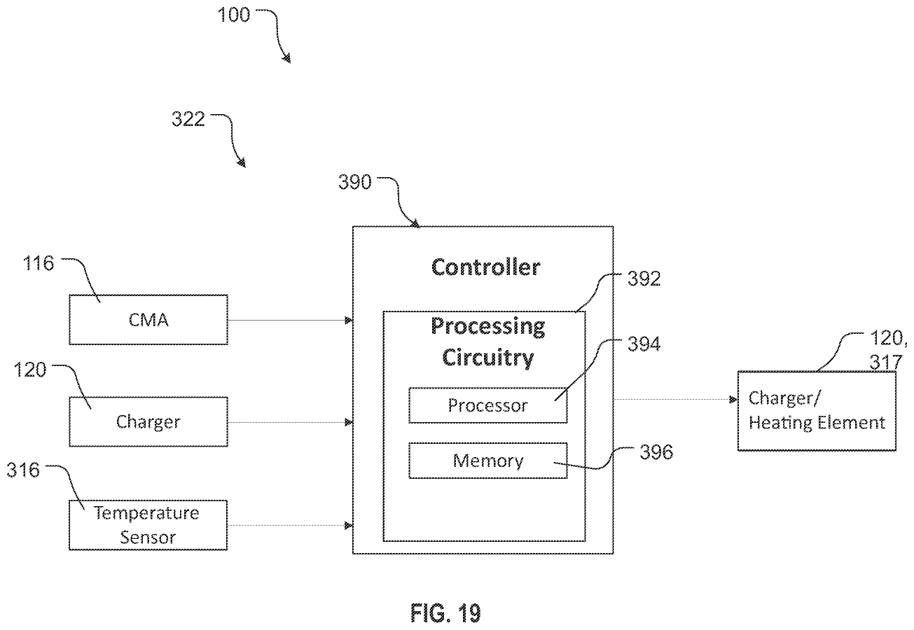

For example, the battery management system 322 can include a controller 390 with a processing circuit 392 having a processor 394 and memory 396 (see, e.g., FIG. 19). The processing circuit 392 can be communicably connected to a communications interface such that the processing circuit 392 and the various components thereof can send and receive data via the communications interface. The processor 394 can be implemented as a general purpose processor, an application specific integrated circuit (“ASIC”), one or more field programmable gate arrays (“FPGAs”), a group of processing components, or other suitable electronic processing components.

The memory 396 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 396 can be or include volatile memory or non-volatile memory. The memory 396 can include database components, object code components, script components, or any other type of information structure for supporting the various activities and information structures described in the present application. According to some embodiments, the memory 396 is communicably connected to the processor 394 via the processing circuit 392 and includes computer code for executing (e.g., by the processing circuit 392 and/or the processor 394) one or more processes described herein. In some embodiments, the controller 390 performs the control functions of the battery management system 322 and/or the charger 120 described herein.

In some embodiments, the controller 390 is in communication with the CMA 116, the charger 120, a temperature sensor(s) (e.g., thermistors 317 or another temperature sensor arranged within the housing 102), and the tape 317. The controller 390 is configured to detect the temperature within the housing 102 (e.g., within the interior cavity 104) and/or of the battery cells of the CMA 116 and instruct the charger 120 to dissipate heat (e.g., via electrical discharge through a resistive heating element, the tape 317, or any other heating mechanisms described herein), in response to the temperature within the housing 102 being below a threshold value.

The battery pack 100 can be connected in series or parallel because the charger 120 and the battery management system 322 are arranged within the battery pack 100. In some embodiments, the same charger 120 and battery management system 322 may be used with a battery pack 100 that has a nominal voltage (V) of 24V, 36V, 48V, 96V, or 120V.

In some embodiments, the charger 120 is configured to output a nominal voltage between 24V and about 120V. In some embodiments, the charger 120 is configured to output at least one of 24V, 36V, 48V, 96V, or 120V when the CMA 116 is fully charged (e.g., as permitted by the battery management system 322) and/or when connected to an external supply power (e.g., an AC power from an AC power supply connected to AC input terminals of the battery pack 100). In some embodiments, the battery pack 100 has an energy storage capacity of at least 1 kilowatt hours of energy. In some embodiments, the CMA 116 are configured to supply at least 1 kilowatt hours of energy when the plurality of battery cells are fully charged. In some embodiments, the CMA 116 is configured to nominally supply about 1 kilowatt hours of energy, about 4 kilowatt hours of energy, about 5 kilowatt hours of energy, about 10 kilowatt hours of energy, or about 35 kilowatt hours of energy when the CMA 116 is fully charged. Such capacities can support an expected power requirement of an operation of the equipment. For example, in some embodiments, mower 10 is commercial mower having a 50″ mowing deck and may be expected to consume about 35 kilowatt hours of energy for a full day of use.

The maximum charge capacity of the battery cells 302 of the CMA sections 370 in the CMA 116 decay over the life of the CMA 116 as the CMA 116 ages. This decay is caused by the battery pack 100 being cycled by discharging and then recharging the battery pack 100, changes in temperature (e.g., high temperatures), and degradation of the chemistry of the battery cells 302. A cycle is the transition from the battery pack's fully charged state (as supplied by the charger 120 and permitted by the battery management system 322) to a partially or fully discharged state (as permitted by the battery management system 322). As the number of cycles increases over the life of the battery pack 100, the battery pack 100's maximum charge capacity declines. Similarly, as the number of cycles increases over the life of the battery pack 100, the efficiency of the CMA 116 also declines (e.g., due to a chemical breakdown of the battery cells 302), and the resulting heat generated by the CMA 116 increases per unit of power (e.g., per watt) exchanged with the CMA 116.

In some embodiments, the battery management system 322 of the battery pack 100 may include an integrated data logger and may be programmed to store data related to the operation of the CMA sections 370 in a memory of the battery management system 322. The information recorded by the battery management system 322 may then be used to determine an anticipated thermal load and a useful life measurement for each CMA. The useful life measurement may be expressed in terms of a percentage of life (e.g., the CMA section 370 is at 100% life when brand new).

Referring to FIGS. 10-12 and 15, the battery management system 322 includes several connectors on one side of the battery management system 322. The input and output components of the battery management system 322 may be fused to the battery management system 322 with resettable fuses. In some embodiments, a battery management system cover 324 is positioned surrounding the battery management system 322. The battery management system cover 324 can provide protection for the battery management system 322 and the connectors and connections to various harnesses coupled to the battery management system 322. In some embodiments, the battery management system cover 324 is a structural potting box that is crush and impact resistant, as well as metal, thermal, and electronic magnetic interference (EMI) resistant. The battery management system 322 includes thermistor connectors 326 for monitoring temperature of each of the CMA sections 370 of the CMA 116. The battery management system 322 includes CMA voltage connectors 320 to receive data on the operation of the battery cells 302 and CMA sections 370 throughout the battery pack 100. In some embodiments, a measurement read at positive voltage tap 332 is communicated to the battery management system 322 via the CMA voltage connectors 320. Each connector of the battery management system 322 may couple to a connection harness (e.g., a shunt harness, etc.).

In some embodiments, the battery management system 322 includes a pre-charge circuit and a bleed circuit integrated into the same board of the battery management system 322. In some embodiments, the battery management system 322 is on the same board as the charger 120. In some embodiments, the battery management system 322 is relatively thermally insignificant (e.g., has few thermally inefficient devices and does not generate a significant amount of heat relative to the heat output associated with a charging operation of the charger 120). In some embodiments, the battery management system 322 includes electrical elements that are particularly sensitive to temperature fluctuations (e.g., processors, solid-state electronic devices, etc.) that experience performance deterioration when exposed to temperatures outside of a particular temperature band (e.g., between 33 and 100 degrees Fahrenheit). In such embodiments, the sensitive electrical elements may be spaced from some or all of the charger 120. For example, the battery management system 322 may be mounted to an interior surface of the housing 102 or a side of the CMA 116 distal the charger 120. In this way, heat attributed to operation of the charger 120 may have a smaller thermal influence on the battery management system 322. In other embodiments, the battery management system 322 is a portion of the charger 120. In some embodiments, the battery management system 322 is on the same board as the charger 120. In some embodiments, the charger 120 and the battery management system 322 are within a same cover (e.g., battery management system cover 324) within the interior cavity 104. In some embodiments, the battery management system 322 is mounted to the base 108 proximate the charger 120. In some embodiments, some or all of the battery management system 322 is at least partially embedded into the housing 102. For example, the electrical components of the battery management system 322 and the charger 120 may be built onto or within a portion of the base 108. In some embodiments, the base 108 is electrically isolated.

In some embodiments, the battery management system 322 conducts a current profile of the battery pack 100 to detect what components are electrically coupled to the terminals of the battery pack 100 (e.g., positive terminal 114, negative terminal 110, data terminal 112, AC input terminals, AC output terminals, DC input terminals, DC output terminals, etc.). When an abnormal profile of the battery pack 100 is detected, the battery management system 322 may signal an alarm as a notification of the abnormality. In some embodiments, when the battery pack 100 is connected in parallel or series with another battery pack, the battery management system 322 writes to the neighboring battery management system 322 of the connected battery pack 100 to manage (e.g., update, restore, etc.) firmware on the neighboring battery management system 322 and may replace old firmware with different (e.g., new) firmware.

In some embodiments, the battery management system 322 can also be configured to update a charger, or other energy source, connected to the battery pack 100 with newer firmware and can receive updates from the charger with newer firmware. For example, the battery management system 322 may be connected to a more recently manufactured battery pack 100 having a more recently manufactured battery management system 322 having different firmware, and based on the connection to the newer battery management system 322, the older battery management system 322 may receive the different firmware (e.g., via an API or one or more communication protocols) directly from the newer battery management system 322 (e.g., by creating or otherwise obtaining a copy or image of the different firmware of the newer battery management system 322).

In some embodiments, the battery management system 322 can operate in three different states, recharge, charge, and hybrid. During the hybrid state, the battery management system 322 may effectively charge the battery pack 100 when meant to be discharging, with or without communication. During the charging state, the battery management system 322 may use adaptive charge limits. For example, if receiving regenerative charging, where the charge of battery pack 100 is being topped off, the battery management system 322 may lower the top end charge limit to avoid a top end fault due to regenerative charging. The decision of the battery management system 322 to lower the top end charge limit may be based on a frequency of fault occurrence.

The CMA 116 can also include a communication harness 336, a negative cable assembly 338, a contactor-to-contactor busbar 340, a positive cable assembly 342, a positive terminal-to-contactor busbar 344, battery pack dual contactors 350, contactor coil terminals 352, negative CMA-to-ground cable assembly 356, series tier flexible busbars 358, shunt isolators 362, and a CMA cell holder 364. In some embodiments, the communication harness 336 connects the panel-mount data connection terminal 112 to the battery management system 322. The negative CMA-to-ground cable assembly 356 may run underneath the CMA 116 and up to an end-of-string mount assembly 312, using negative cable routing, from the first CMA section 370 block to the ground 372 of the last CMA section 370 block. In some embodiments, the negative CMA-to-ground assembly is routed from a first CMA section 370 on the top tier of the battery pack 100, down the front side of the CMA 116, below a base plate of the battery pack 100, and up a rear side of the CMA 116 to connect to a last CMA section 370 on the bottom tier of the CMA 116. The series tier flexible busbars 358 electrically connect the various tiers of the battery pack 100. In some embodiments, the CMA cell holder 364 is a bottom CMA cell holder frame (e.g., bottom CMA cell holder frame) coupled to the negative terminals of the battery cells 302 for each CMA section 370.

Referring to FIG. 10, the contactor-to-contactor busbar 340 extends to a position near the top of the CMA 116, and can be coupled with a plurality of CMA sections 370 simultaneously. The positive cable assembly 342 extends to the positive terminal 114. The negative cable assembly 338 extends upward to the negative terminal 110. The communication harness 336 extends upward from the battery management system 322 to the data connection terminal 112. In some embodiments, the battery management system cover 324 and the top plate 318 form a top portion of the CMA 116. In other embodiments, the top plate 318 for the top portion of the CMA 116.

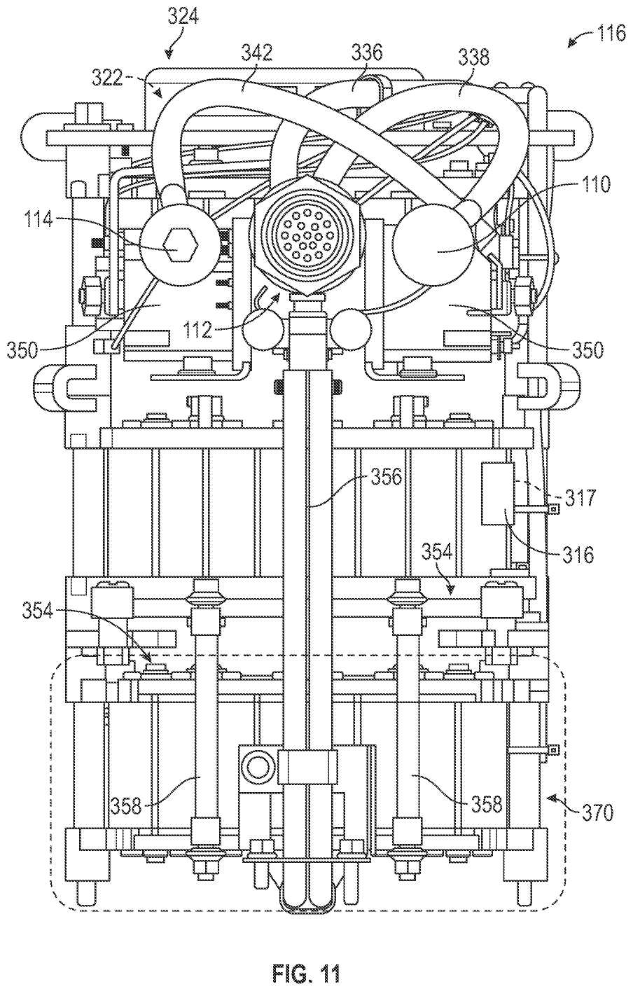

Referring to FIG. 11, the bottom of the CMA 116 includes a base plate 374 and bottom collector plates 376. Each bottom collector plate 376 is coupled to the bottom of each CMA section 370 of the battery pack 100. The negative CMA-to-ground cable assembly 356 runs beneath the battery pack 100. In some embodiments, some of the bottom collector plates 376 may be negative collector plates coupled to the negative terminals of the battery cells 302 in a CMA section 370. Other bottom collector plates 376 are positive collector plates coupled to the positive terminals of the battery cells 302 in a CMA section 370 of the bottom tier of the battery module assembly.

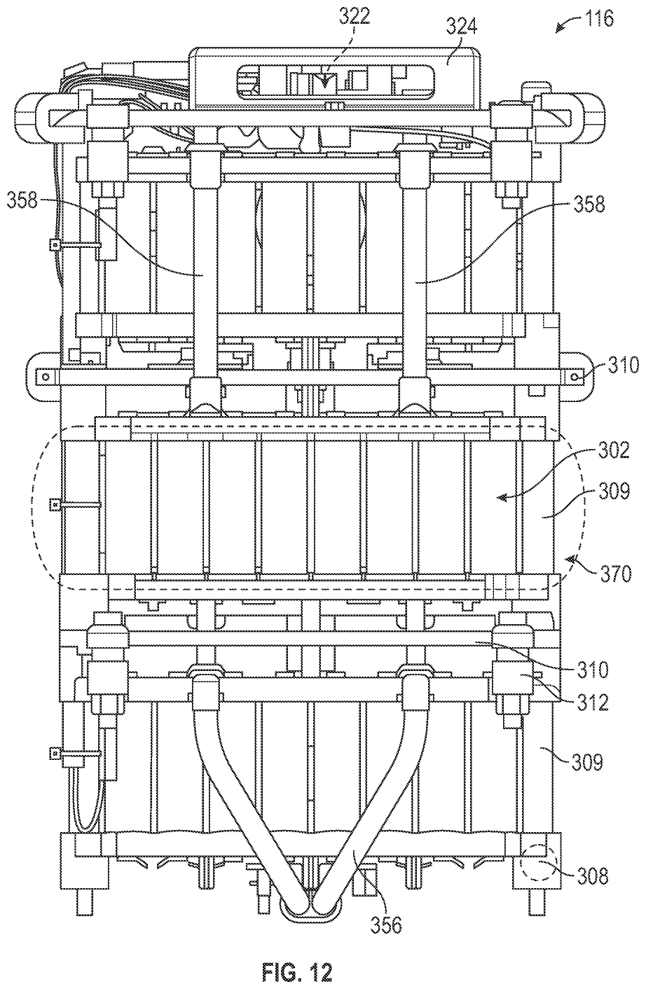

Referring to FIGS. 11 and 12, the battery management system 322 is positioned inside of the battery management system cover 324 and on top of three different tiers of CMA sections 370 in the battery pack 100. The contactors 350, the positive terminal 114, the panel-mount data connection terminal 112, the negative terminal 110, the positive cable assembly 342, the negative cable assembly 338 and the communication harness 336 are each positioned near the front of the battery pack 100. In some embodiments, the dual contactors 350, the positive terminal 114, the negative terminal 110, and the panel-mount data connection terminal 112 are positioned in line with the top tier of the battery pack 100. The tape 316 and thermistor 317 are each coupled to a battery cell 302 of a CMA section 370 in the battery pack 100. In some embodiments, each CMA section 370 of the battery pack 100 includes one thermistor 317 in order to monitor the current temperature levels of each CMA section 370 throughout the battery pack 100. As such, the variability in temperature throughout the battery pack 100 may be tracked and managed by the battery management system 322. The different tiers of the battery pack 100 can also be seen from a front of the battery pack 100. In some embodiments, the battery pack 100 may have more or less than three tiers of CMAs.

Referring again to FIG. 3, the three tiers of the CMA 116 are depicted. The charger 120 is positioned below the bottom tier of the CMA 116. The charger 120 is coupled to the positive cable assembly 342, and the negative cable assembly 338. In some embodiments, the negative cable assembly 338 includes a negative cable connecting the negative terminal 110 to an input negative terminal 380 of the charger 120, and a negative cable connecting an output negative terminal 382 of the controller to the CMA 116 (e.g., by connecting to a negative terminal of the battery management system 322). In some embodiments, the positive cable assembly 342 includes a positive cable connecting the positive terminal 114 to an input positive terminal 386 of the charger 120, and a positive cable connecting an output positive terminal 388 of the charger to the battery module assembly (e.g., by connecting to a positive terminal of the battery management system 322). In some embodiments, the battery management system 322 is configured to communicably connect with the charger 120 (e.g., via a wireless connection, via a wired connection, via a serial connection, etc.) such that the output of the charger 120 may respond to a command generated by the battery management system 322.

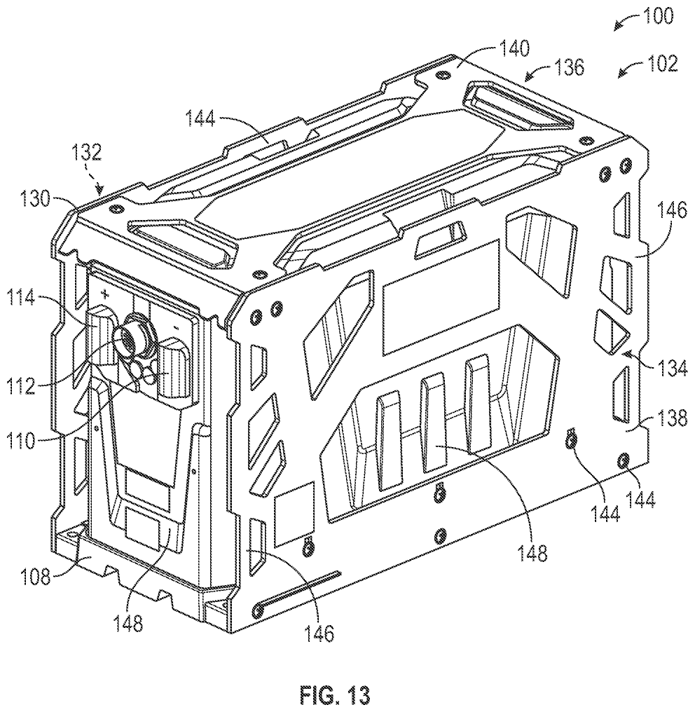

Referring to FIGS. 13-18, the battery pack 100 may is depicted, according to some embodiments. The battery pack 100 of FIGS. 1-8 is similar to the battery pack 100 of FIGS. 13-18, with like features identified using the same reference numerals, except as described herein or as apparent from the figures. As shown in FIGS. 13-18, the charger 120 is coupled to the base 108 of the housing 102, and the charger 120 may occupy a space below the middle tier of CMAs of the CMA 116 and adjacent to an interior surface of a front panel of the housing 102 (e.g., a panel that includes the negative terminal 110 and the positive terminal 114).

In some embodiments, the charger 120 occupies a volumetric unit equivalent to or similar to that of a volumetric unit occupied by a CMA section 370. The charger 120 may be proximate the bottom tier of the CMA 116. For example, the charger 120 may occupy a portion of the interior cavity 104 that is intersected by a plane containing a tier of CMAs. In some embodiments the charger 120 occupies less than 10% of the volume of the interior cavity 104.

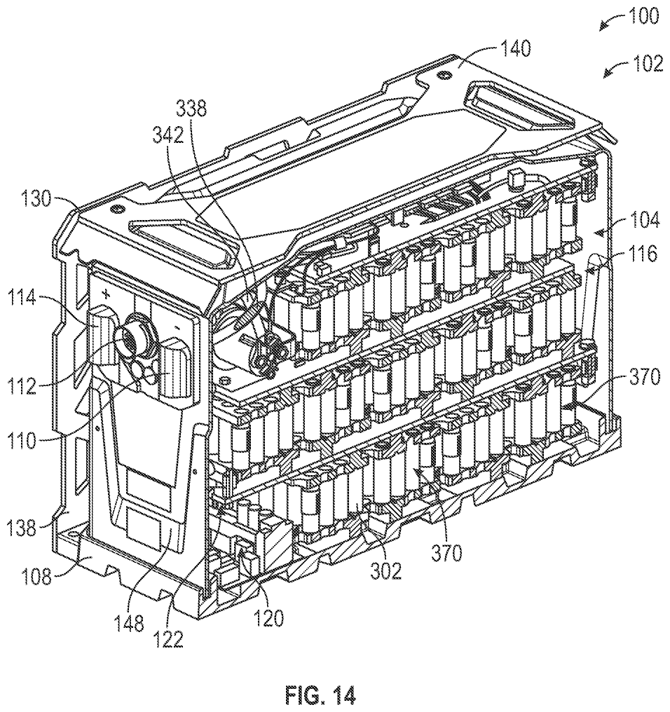

In some embodiments, the CMA 116 at least partially surrounds the charger 120 by supporting one or more battery cells 302 proximate one or more sides of the charger 120. In some embodiments, the charger 120 is surrounded by the CMA 116 on one side of the charger 120. For example, the CMA 116 may surround the charger 120 on a top side of the charger 120 within the interior cavity 104 (see, e.g., FIG. 3). In some embodiments, the CMA 116 surrounds the charger 120 on two sides of the charger 120. For example, the CMA 116 may surround the charger 120 on a top side and a rear side of the charger 120 (as shown in FIG. 14). In some embodiments, the CMA 116 surrounds the charger 120 on three sides of the charger 120. For example, the CMA 116 may surround the charger 120 on a top side, left side, and a right side of the charger 120. As another example, the CMA 116 may surround the charger 120 on a top side, right side, and rear side of the charger 120. In some embodiments, the CMA 116 surrounds the charger 120 on four sides of the charger 120. For example, the CMA 116 may surround the charger on a top side, left side, right side, and back side of the charger 120. In some embodiments, the CMA 116 surrounds the charger 120 on five sides of the charger 120. For example, the CMA 116 may surround the charger 120 on a top side, left side, right side, back side, and front side, of the charger 120.

Referring to FIGS. 13 and 14, the CMA 116 is coupled to the base 108, according to some embodiments. The charger 120 is coupled to the positive cable assembly 342 and the negative cable assembly 338. The negative cable assembly 338 includes a negative cable connecting the negative terminal 110 to the input negative terminal 380 of the charger 120, and a negative cable connecting the output negative terminal 382 of the controller to the CMA 116. The positive cable assembly 342 includes a positive cable connecting the positive terminal 114 to the input positive terminal 386 of the charger 120, and a positive cable connecting the output positive terminal 388 of the charger 120 to the CMA 116. The battery management system 322 is communicably connected to the charger 120. In some embodiments, all of the power entering and exiting the battery pack 100 is directed through the charger 120. For example, all of the power entering the battery pack 100 (e.g., via the positive terminal 114, the negative terminal 110, and data terminal 112), may be supplied to a input terminal(s) of the charger 120 and processed by the charger 120 (e.g., filtered, converted, stepped up, stepped down, passed through). After being processed, the input power may be output from the charger 120 at output terminal(s) arranged within the interior cavity 104 that are connected to at least one of the CMA 116 (to facilitate storing energy), or the power output terminals of the battery pack 100 (e.g., positive terminal 114, negative terminal 110, data terminal 112).

In some embodiments, the charger 120 has an efficiency between approximately 80% to approximately 90%. For example, if the charger 120 is supplied 1 kW (1,000 watts), of power (e.g., at the input terminals of the charger 120), the charger 120 may output between 0.8 and 0.9 kW of electrical power at the output terminals of the charger 120, while the remainder of the power supplied is dissipated predominantly in the form of heat. In some embodiments, the charger 120 outputs between 0 and approximately 0.6 kW of power at the output terminals of the charger 120. In some embodiments, the charger 120 outputs between 0 and approximately 1 kW of power at the output terminals of the charger 120. In some embodiments, the charger 120 conductively displaces between 100 and 150 watts of power into the housing 102 (e.g., via conductive heat transport into base 108).

In some embodiments, the charger 120 is configured to operate below the rated maximum efficiency of the charger 120 such that additional energy is dissipated as heat in the battery pack 100. For example, the charger 120 may intentionally operate with an efficiency to between approximately 0% and approximately 70% to heat a battery pack to a temperature above 0 degrees Celsius. In some embodiments, most of the heat dissipated by the charger 120 is conductively transferred into the housing. In some embodiments, most of the heat applied to the housing of the battery pack (e.g., from solar heat, heat generated by the CMA 116, from heat generated by the charger 120, from heat generated by the connections and conduits with the interior cavity 104, etc.) is transferred from the outer surfaces of the battery pack 100 into ambient fluid (e.g., air) proximate the battery pack 100 via at least one of natural convection (e.g., due to buoyancy of the heated ambient fluid), or forced convection (e.g., due to a stream of air being blown or actively moved over the external surfaces of the battery pack 100). In some embodiments, the hottest components of charger 120 (e.g., a transformer, capacitors, semiconductors, etc.) are positioned proximate the housing 102. In some embodiments, the base 108 is electrically insulated from some or all of the power entering and/or exiting the charger 120. For example, the base 108 may be electrically insulated from an input AC power supplied to the charger 120.

Referring to FIGS. 2-18, the charger 120 is advantageously coupled to the housing 102 and heat may be transferred into the housing 102, according to some embodiments. In this way, the thermal properties of the charger 120 are stabilized via exchange of thermal energy with the housing 102 and/or the base 108. For example, the base 108 may be have a higher thermal capacitance relative to the thermal capacitance of some or all of the charger 120, and may thereby effectively increase the thermal capacitance available to the charger 120 (e.g., when the temperature of the charger 120 exceeds the temperature of the base 108). Advantageously, the battery pack 100 facilitates an improved protection of the charger 120 from debris, water, other potential contaminants, and thermal dysregulation that may undesirably influence the performance of the charger 120, and provides for a streamlined and efficient application of a battery pack 100 powering outdoor power equipment. The battery pack 100 beneficially facilitates an improved user experience by requiring fewer electrical connections and electrical devices, and thereby reduces the number of devices a user is required to store, transport, maintain, and generally keep track of, in order to enable one or more applications of a battery (e.g., the battery pack 100 powering the mower 10).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the battery pack 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A battery pack, comprising:
a housing defining an internal cavity;
a first positive terminal extending through the housing;
a first negative terminal extending through the housing;
a plurality of battery cells within the internal cavity, the plurality of battery cells being electrically coupled to the first positive terminal and the first negative terminal; and
a battery charger within the internal cavity, the battery charger configured to charge the plurality of battery cells and comprising:
a second positive terminal electrically coupled to the first positive terminal within the housing; and
a second negative terminal electrically coupled to the first negative terminal within the housing.

2. The battery pack of claim 1, wherein the housing comprises a base and a cover, wherein the cover is configured to sealingly couple to the base.

3. The battery pack of claim 2, wherein the base is formed from a thermally conductive material, wherein the battery charger is coupled to the base, and wherein the battery charger is configured to transfer heat generated by the battery charger into the base.

4. The battery pack of claim 3, wherein the battery charger is coupled to the base below the plurality of battery cells.

5. The battery pack of claim 3, wherein the battery charger is coupled to the base below a first portion of the plurality of battery cells and adjacent to a second portion of the plurality of battery cells.

6. The battery pack of claim 3, wherein the plurality of battery cells are configured to output a nominal voltage between the first positive terminal and the first negative terminal between about 24 V and about 120 V.

7. The battery pack of claim 3, wherein the plurality of battery cells are configured to nominally supply at least 1 kilowatt hours of energy.

8. The battery pack of claim 3, wherein the plurality of battery cells are configured to nominally supply at least 1 kilowatt hours of energy when the plurality of battery cells are fully charged.

9. The battery pack of claim 3, wherein the plurality of battery cells are configured to nominally supply between about 1 kilowatt hours of energy and about 35 kilowatt hours of energy when the plurality of battery cells are fully charged.

10. The battery pack of claim 3, wherein the plurality of battery cells are lithium ion battery cells, and wherein the plurality of battery cells are configured to nominally supply about 1 kilowatt hours of energy, about 4 kilowatt hours of energy, about 5 kilowatt hours of energy, about 10 kilowatt hours of energy, or about 35 kilowatt hours of energy when the plurality of battery cells are fully charged.

11. The battery pack of claim 2, wherein the battery charger is coupled to the housing, and wherein the battery charger is configured to transfer heat generated by the battery charger into the housing.

12. The battery pack of claim 1, wherein the housing comprises one or more cooling features formed in the housing, wherein the one or more cooling features direct heat away from the internal cavity such that a temperature within the internal cavity remains below a threshold value without using forced convention.

13. The battery pack of claim 12, further comprising a plurality of plates coupled to a base, the plurality of plates partially enclosing the housing, and wherein the plurality of plates are configured to receive heat from the base via conduction, and dissipate heat via natural convection.

14. A battery pack comprising;
a housing defining an internal cavity;
a first positive terminal;
a first negative terminal;
a plurality of battery cells within the internal cavity, the plurality of battery cells being electrically coupled to the first positive terminal and the first negative terminal;
a temperature sensor mounted to the housing or the plurality of battery cells; and
a battery charger within the internal cavity, the battery charger being configured dissipate energy into the housing, when a temperature measurement of the temperature sensor is below a threshold value.

15. The battery pack of claim 14, wherein the housing comprises a base and a cover, wherein the cover is configured to sealingly couple with the base.

16. The battery pack of claim 15, wherein the base is formed from a metal material, wherein the battery charger is coupled to the base, and wherein the battery charger is configured to transfer heat generated by the battery charger into the base.

17. The battery pack of claim 16, wherein the plurality of battery cells are arranged in at least a first tier of cell module assemblies (CMAs) and a second tier of CMAs, wherein the second tier of CMAs is separated from the base by the first tier of CMAs.

18. The battery pack of claim 17, wherein the battery charger is coupled to the base below the second tier of CMAs.

19. The battery pack of claim 17, wherein the battery charger is coupled to the base below the second tier of CMAs and the first tier of CMAs.

20. Outdoor power equipment, comprising:
a frame;
a prime mover;
a wheel coupled to the frame; and
a battery pack supported on the frame and configured to electrically power the prime mover, the battery pack comprising:
a housing defining an internal cavity;
a first positive terminal;
a first negative terminal;
a plurality of battery cells within the internal cavity, the plurality of battery cells being electrically coupled to the first positive terminal and the first negative terminal; and
a battery charger within the internal cavity, the battery charger configured to charge the plurality of battery cells and comprising:
a second positive terminal electrically coupled to the first positive terminal within the housing; and
a second negative terminal electrically coupled to the first negative terminal within the housing.

21-25. (canceled)
